(19) United States
(12) Patent Application Publication
(10) Pub. No.: US 2006/0197905 A1
(43) Pub. Date: Sep. 7, 2006

(54) Eyeglasses equipped with lamp circuit assembly

(76) Inventor: Hsiao-Chien Lu, Taipei City (TW)

Correspondence Address: LEONG C LEI, PMB # 1008, 1867 YGNACIO VALLEY ROAD, WALNUT CREEK, CA, 94598, US

(21) Appl. No.: 11/072,426

(22) Filed: Mar. 7, 2005

(51) Int. Cl. G02C 1/00

(52) U.S. Cl. 351/158

(57) ABSTRACT

A pair of eyeglasses is disclosed to have a lamp mounted in the front side of one rim of the eyeglasses frame thereof, an on/off switch mounted on the outside of the eyeglasses frame, and a battery cell and a circuit board mounted in one of the two temples of the eyeglasses frame and electrically connected in series to the lamp through the on/off switch for driving the lamp to give off light for illumination when the user switched on the on/off switch.

### BACKGROUND OF THE INVENTION

(a) Technical Field of the Invention

The present invention relates generally to a pair of eyeglasses and more specifically, to a pair of eyeglasses that is equipped with a lamp circuit assembly.

(b) Description of the Prior Art

A pair of eyeglasses is an optical instrument consisting of a pair of lenses for correcting defective vision. Eyeglasses manufacturers may use different materials or provide different shape designs to attract consumers. These conventional eyeglasses do not provide an added function.

Further, when reading or watching something under an insufficient illumination environment, a hand lamp may be necessary. However, it is not practical to carry a hand lamp with oneself all the times. Further, a car has lamps provided on the inside for illumination. However, these lamps are provided at fixed locations and not adjustable to different directions. When searching a fallen article inside a car or reading a paper data within a short distance, the fixed lamps inside the car may be unable to provide sufficient illumination.

Further, there are reflective vests, paints, and shoes for use in the dark to reflective light and to give a warning signal to traffics passing by.

### SUMMARY OF THE INVENTION

The primary purpose of the present invention is to provide a pair of eyeglasses, which is equipped with a lamp circuit assembly that enables the user to read things in the dark.

It is another object of the present invention to provide a pair of eyeglasses, which is equipped with a lamp circuit assembly that gives a warning signal to traffics passing by when the user walks or works on the road at night.

It is still another object of the present invention to provide a pair of eyeglasses, which is equipped with a lamp circuit assembly for illumination that does not interfere with normal functioning of the eyeglasses.

To achieve these and other objects of the present invention, the pair of eyeglasses comprises an eyeglasses frame and a lamp circuit assembly installed in the eyeglasses frame.

The lamp circuit assembly comprises a lamp mounted in the front side of one rim of the eyeglasses frame, an on/off switch mounted on the outside of the eyeglasses frame, and a battery cell and a circuit board mounted in one of the two temples of the eyeglasses frame and electrically connected in series to the lamp through the on/off switch for driving the lamp to give off light when the user switched on the on/off switch.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a pair of eyeglasses according to the present invention.

FIG. 2 is a top view of an alternate form of the pair of eyeglasses according to the present invention.

FIG. 3 is a front view of FIG. 2.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

A pair of eyeglasses in accordance with the present invention is substantially similar to conventional eyeglasses, having two rims joined by a bridge, two lenses respectively mounted in the rims, and two temples respectively hinged to the rims.

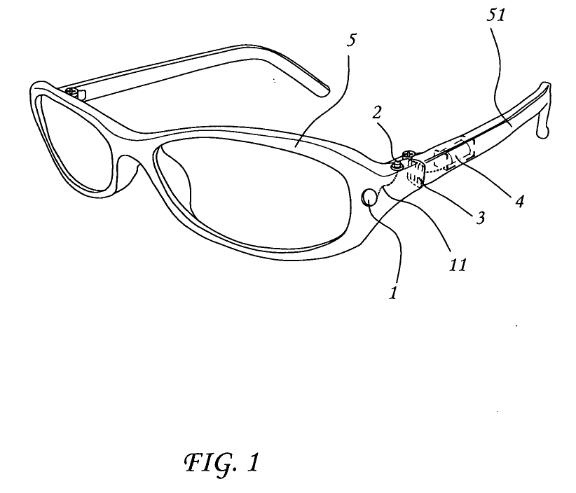

The main feature of the present invention is outlined hereinafter with reference to FIG. 1. The pair of eyeglasses comprises a lamp circuit assembly controllable to provide illumination. The lamp circuit assembly comprises a lamp 1 mounted (in a hole) at one of the two rims thereof and aimed at the front side of the eyeglasses, a circuit board 3 mounted inside one of the two temples 51 thereof, a battery cell 4 mounted inside the same temple 51, an on/off switch 2 mounted on the outside of the same rim 5, and electric wires 11 mounted inside the same rim 5 and the same temple 51 and electrically connecting the lamp 1 to the battery cell 4 through the on/off switch 2 and the circuit board 3 in such a manner that switch on the on/off switch 2 causes the circuit board 3 to transmit battery power from the battery cell 4 to the lamp 1 and to turn on the lamp 1.

When reading a book or the like inside a car or in a place where the intensity of light of insufficient, the user can switch on the on/off switch 2 to turn on the lamp 1. When the user turns the head from one direction to another, the lamp 1 will be moved with the head and aimed at the objective viewed by the user's eyes, providing illumination to the objective.

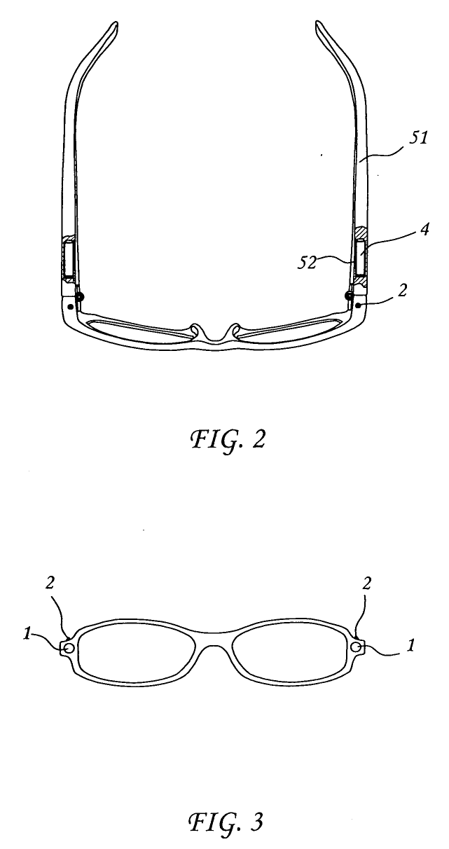

FIGS. 2 and 3 show an alternate form of the present invention. This embodiment is substantially similar to the embodiment shown in FIG. 1 with the exception of an additional lamp circuit assembly, i.e., this embodiment comprises two lamp circuit assemblies provided at two sides. Further, a battery lid 52 may be detachably fastened to the temple 51 corresponding to the battery cell 4 so that the user is easily accessible to the battery cell 4 for a replacement when opened the battery lid 52.

A prototype of eyeglasses has been constructed with the features of FIGS. 1˜3. The eyeglasses functions smoothly to provide all of the features discussed earlier.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pair of eyeglasses comprising a lamp circuit assembly installed in an eyeglasses frame thereof, said eyeglasses frame comprising two rims each holding a lens, a bridge joining said rims, and two temples respectively hinged to said rims, wherein said lamp circuit assembly comprises a battery cell, a circuit board electrically connected to said battery cell, an on/off switch, and a lamp electrically connected to said circuit board and said battery cell through said on/off switch and controllable by said on/off switch to give off light.

2. The pair of eyeglasses as claimed in claim 1, wherein said lamp is installed in one said rim and aiming at a front side of said eyeglasses frame.

3. The pair of eyeglasses as claimed in claim 1, wherein said eyeglasses frame comprises a battery lid adapted to protect said battery cell and to hold said battery cell in place.
